(19) United States
(12) Patent Application Publication
(10) Pub. No.: US 2015/0261444 A1
(43) Pub. Date: Sep. 17, 2015

(54) MEMORY SYSTEM AND INFORMATION PROCESSING DEVICE

(71) Applicant: Kabushiki Kaisha Toshiba, Minato-ku (JP)

(72) Inventors: Kenichiro YOSHII, Bunkyo-ku (JP); Naomi TAKEDA, Yokohama-shi (JP); Hiroshi YAO, Yokohama-shi (JP); Nobuhiro KONDO, Yokohama-shi (JP)

(73) Assignee: Kabushiki Kaisha Toshiba, Minato-ku (JP)

(21) Appl. No.: 14/334,788

(22) Filed: Jul. 18, 2014

Related U.S. Application Data
(60) Provisional application No. 61/951,835, filed on Mar. 12, 2014.

(51) Int. Cl. G06F 3/06

(52) U.S. Cl. CPC G06F 3/0608; G06F 3/0688; G06F 3/0661

(57) ABSTRACT

According to one embodiment, a memory system includes a first memory, an interface, and a control unit. The first memory can operate in first mode in which n (n≧2) pieces of unit data are written per word line and in second mode in which one piece of unit data is written per word line. When n pieces of unit data to be written to the first word line exist in the second memory, the control unit writes the first unit data to the first word line, using the n pieces of unit data to be written to the first word line. When receiving a flush request, the control unit writes a second unit data to a second word line, the second unit data being unit data stored in the second memory, based on the second mode.

### CROSS-REFERENCE TO RELATED APPLICATIONS

This application is based upon and claims the benefit of priority from U.S. Provisional Application No. 61/951,835, filed on Mar. 12, 2014; the entire contents of which are incorporated herein by reference.

### FIELD

Embodiments described herein relate generally to a memory system and an information processing device.

### BACKGROUND

For the purpose of increasing capacity, a recent NAND flash memory is configured to shrink a memory cell and store the value of multiple bits in one memory cell. A voltage to be applied to a memory cell needs to be minutely controlled to store the value of multiple bits in one memory cell. Specifically, it is necessary to also take into account the influence of a voltage set for a word line (a group composed of a plurality of memory cells electrically connected) adjacent to a word line belonging to a memory cell in which a value is intended to be stored. Accordingly, it is necessary to perform a plurality of writes per word line while switching word lines to be written for every write.

### BRIEF DESCRIPTION OF THE DRAWINGS

FIG. 1 is a diagram illustrating a configuration of an information processing device of a first embodiment;

FIG. 2 is a diagram illustrating the order of writes when the value of three bits can be stored in each memory cell;

FIG. 3 is a diagram illustrating a rule to decide a write destination page during operation in MLC mode, and write timings;

FIG. 4 is a diagram illustrating the transition of a stored content in a device area during operation in MLC mode;

FIG. 5 is a flowchart illustrating the operation of a memory system of a first embodiment;

FIG. 6 is a diagram illustrating a configuration of an information processing device of a second embodiment;

FIG. 7 is a flowchart illustrating the operation of a memory system of the second embodiment;

FIG. 8 is a diagram illustrating a configuration of an information processing device of a third embodiment; and

FIG. 9 is a flowchart illustrating the operation of a memory system of the third embodiment.

### DETAILED DESCRIPTION

In general, according to one embodiment, a memory system includes a first memory, an interface, and a control unit. The first memory includes a non-volatile memory cell array having a plurality of word lines. The first memory can operate in first mode in which n (n≧2) pieces of unit data are written per word line and in second mode in which one piece of unit data is written per word line. The interface is connected to an external second memory. The first mode is a mode in which a plurality of pieces of unit data are written in a predetermined order, and word lines to be written are switched for every write of the unit data. When receiving a write request, the control unit decides a first word line to which first unit data is written, the first unit data being data requested to be written, based on the first mode, and stores the first unit data in the second memory. When it is the turn of the first unit data, and when n pieces of unit data to be written to the first word line exist in the second memory, the control unit acquires, from the second memory, the n pieces of unit data to be written to the first word line, and writes the first unit data to the first word line, using the acquired n pieces of unit data to be written to the first word line. When receiving a request to write all pieces of data existing in the second memory to the first memory, the control unit decides a second word line to which second unit data is written, the second unit data being unit data stored in the second memory, based on the second mode, acquires the second unit data from the second memory, and writes the second unit data to the second word line.

Exemplary embodiments of a memory system and an information processing device will be explained below in detail with reference to the accompanying drawings. The present invention is not limited to the following embodiments.

### First Embodiment

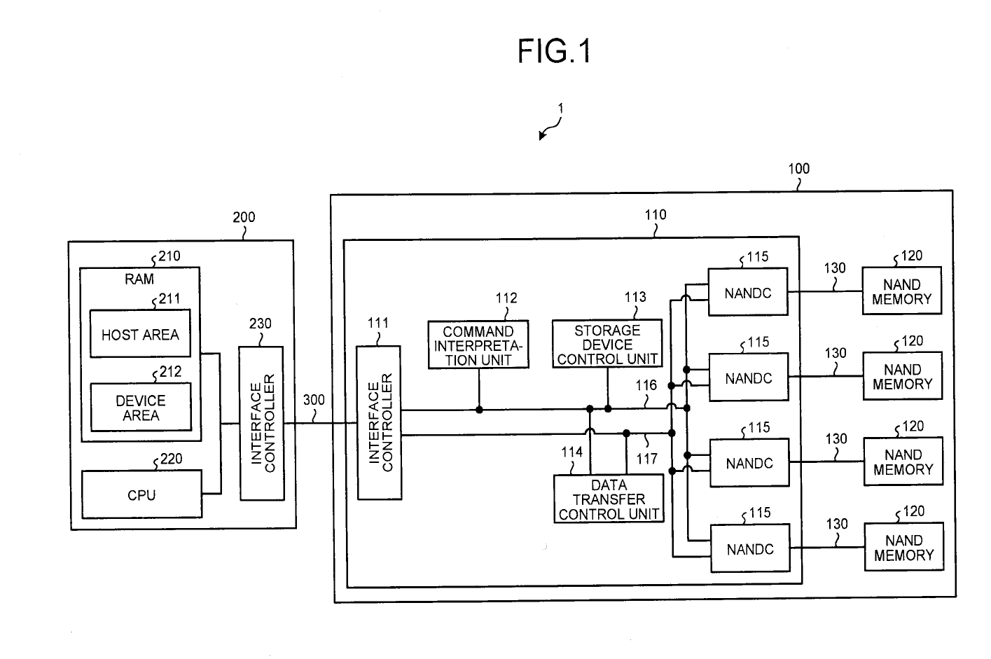

FIG. 1 is a diagram illustrating a configuration of an information processing device of a first embodiment. An information processing device 1 includes a memory system 100 and a host 200. The memory system 100 and the host 200 are connected to each other via a communication line 300. The information processing device 1 is, for example, a personal computer, a mobile phone, or an imaging apparatus. Any standards can be applied respectively to a standard with which the memory system 100 is compliant and a standard of the communication line 300.

The host 200 includes a RAM 210, a CPU 220, and an interface controller 230. The RAM 210, the CPU 220, and the interface controller 230 are connected to each other via a bus. The RAM 210 includes a host area 211 and a device area 212.

The CPU 220 operates based on a predetermined program. The CPU 220 generates data to be written to the memory system 100 in the host area 211. The CPU 220 can subsequently issue a request to write the data generated in the host area 211 to the memory system 100 (a WRITE command).

The interface controller 230 can transfer data between the host area 211 and the device area 212. Moreover, the interface controller 230 can transfer data between the device area 212 and an interface controller 111 of the memory system 100. Moreover, the interface controller 230 transfers the WRITE command issued by the CPU 220 to the memory system 100 via the communication line 300.

The memory system 100 includes a memory controller 110 and a plurality of (four in here) NAND flash memories (NAND memories) 120. The memory controller 110 includes the interface controller 111, a command interpretation unit 112, a storage device control unit 113, a data transfer control unit 114, and a plurality of (four in here) NAND controllers (NANDCs) 115. The interface controller 111, the command interpretation unit 112, the storage device control unit 113, the data transfer control unit 114, and the four NANDCs 115 are connected to each other via a control bus 116. Moreover, the interface controller 111, the data transfer control unit 114, and the four NANDCs 115 are connected to each other via a data bus 117.

The NAND memories 120 are respectively connected to different NANDCs 115 via a channel 130. Each channel 130 includes an I/O signal line and a control signal line. The NAND memories 120 are respectively connected to the different channels 130. Accordingly, the memory controller 110 can operate the NAND memories 120 independently of each other. The number of the NAND memories 120 included in the memory system 100 can be any number. Moreover, the connection relationship of the channel 130 can be configured freely.

The interface controller 111 is connected via the communication line 300 to the interface controller 230 included in the host 200. The interface controller 111 can transfer data to and from the interface controller 230. Moreover, the interface controller 111 can receive various commands issued by the CPU 220 and transmitted via the interface controller 230 and the communication line 300.

The NANDC 115 can write and read data to and from the NAND memory 120.

The data transfer control unit 114 can transfer data between the NANDC 115 and the interface controller 111.

The command interpretation unit 112 interprets the command received by the interface controller 111 and transmits the interpretation result to the storage device control unit 113. The storage device control unit 113 controls the components (the interface controller 111, the data transfer control unit 114, and the NANDC 115) included in the memory controller 110 based on the command interpretation result.

Each NAND memory 120 includes a NAND memory cell array. The memory cell array is configured by arranging a plurality of word lines, each of which is electrically connected to a plurality of memory cells. The memory cell array includes a plurality of blocks as erasure units. Each block includes a plurality of word lines.

Each NAND memory 120 can operate in both modes: a mode (MLC mode) in which the value of two or more bits are stored in each memory cell, and a mode (SLC mode) in which only the value of one bit is stored in each memory cell.

The value of one bit is written to each memory cell at one write in MLC mode. Moreover, writes to the memory cells are executed in a unit of a word line. In other words, assuming that the memory cell can store the value of n bits (n is an integer equal to or more than two), writes are performed n times on each word line. On the other hand, a threshold value voltage of the memory cell changes due to the influence of coupling capacity between adjacent memory cells during a write. Word lines to be written are switched whenever one write is complete in order to reduce the influence of coupling capacity on adjacent memory cells.

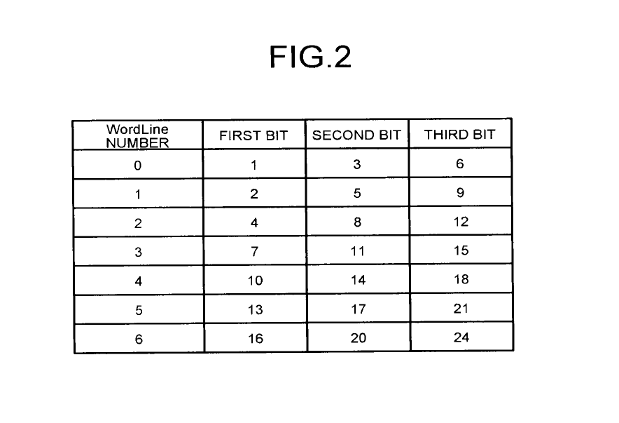

FIG. 2 is a diagram illustrating the order of writes when the value of three bits can be stored in each memory cell. In FIG. 2, a word line number is an identification number assigned to a word line in accordance with the arrangement order of word lines. A word line with word line number i and a word line with word line number i+1 are adjacent to each other. The word line with word line number i is hereinafter expressed as “word line #i.” Moreover, a word line-based storage area containing a first bit of a memory cell is expressed as the lower page, a word line-based storage area containing a second bit of the memory cell as the middle page, and a word line-based storage area containing a third bit of the memory cell as the upper page. Moreover, the lower page, the middle page, and the upper page may collectively be expressed as the page.

As illustrated in FIG. 2, when writes are executed for data of a plurality of pages, write destinations are switched in the order of word line #0, word line #1, word line #0, word line #2, word line #1, and word line #0. Word line #0 is written to the lower page at a first write to a block, written to the middle page at a third write, and written to the upper page at a sixth write. These three writes in total put word line #0 in a state where values have been written in all the first, second, and third bits of the memory cells included in word line #0 (a write complete state). Word lines to be written are subsequently switched in the order of (1) the lower page of word line #i+2, (2) the middle page of word line #i+1, and (3) the upper page of word line #i. After a write to (3) the upper page of word line #i is executed, the value of i is incremented by “one,” and a write to (1) the lower page of word line #i+2 is executed again.

The NAND memory 120 controls a voltage to be applied to a word line for every page-based write such that the word line has a minimum read error at the point when the word line becomes the write complete state. Hence, the NAND memory 120 requires data to be written to all the pages of a word line to be written in order to decide a voltage to be applied to the word line in any of cases a write is executed on the lower page, the middle page, and the upper page. When data of all the pages to be written to one word line is confirmed, a write to the lower page of the word line becomes executable. In the first embodiment, data requested to be written is copied from the host area 211 into the device area 212 at the instruction of the memory system 100. Data required until a write to a new page becomes possible is held in the device area 212.

The order of writes of pieces of page based-data to the NAND memory 120 is determined based on a rule to decide a write destination page and a rule to switch write destination pages for every write.

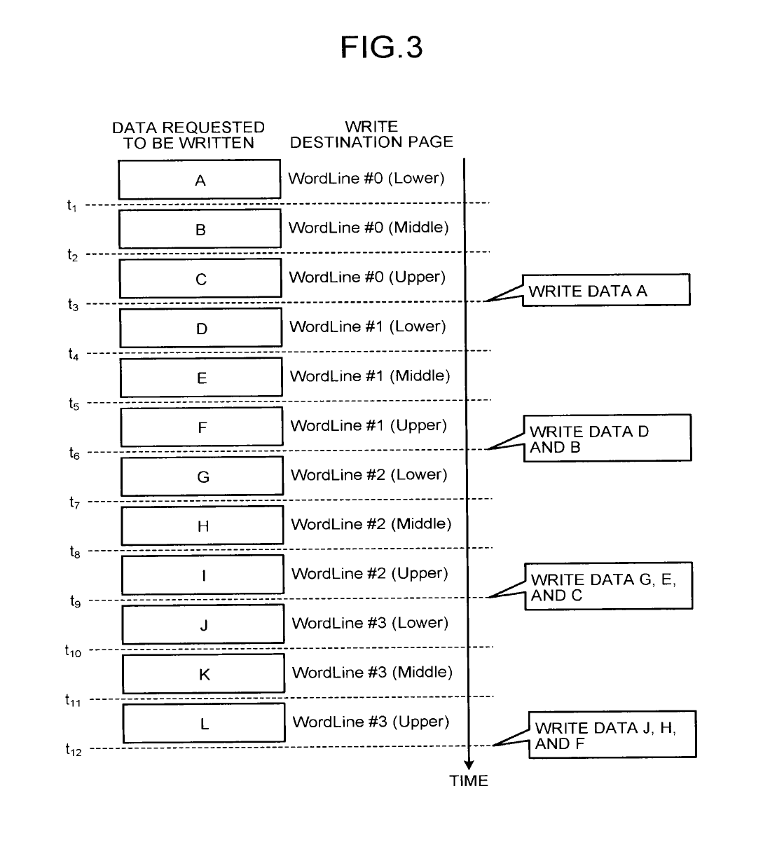

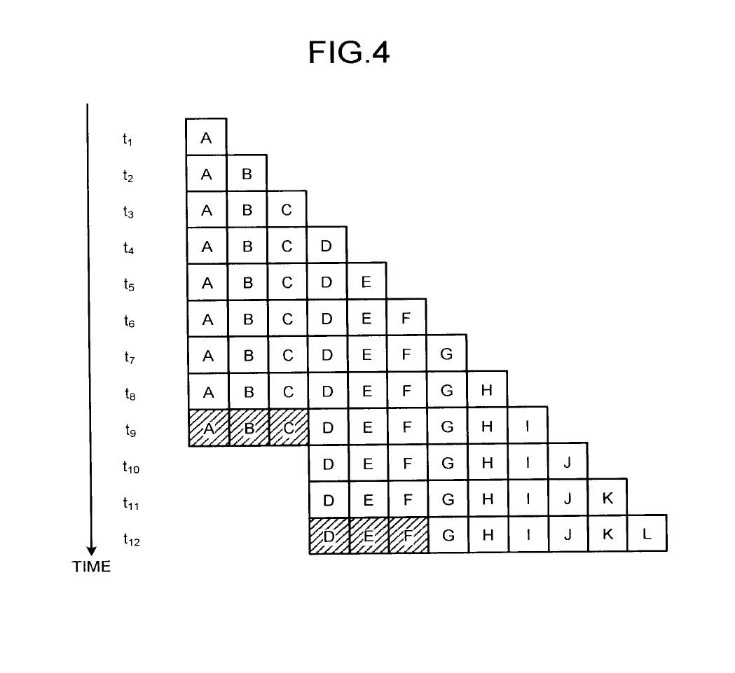

FIG. 3 is a diagram illustrating the rule to decide a write destination page during operation in MLC mode, and write timings. FIG. 4 is a diagram illustrating the transition of a stored content in the device area 212 during operation in MLC mode. Data A to L respectively represent data in a page size. t1 to t12 respectively represent times when the copies of the data A to L into the device area 212 are respectively complete. The data A to L are requested to be written in the order indicated by the alphabets denoted subsequent to “data.” The write destinations of the data A to L are sequentially allocated to the lower page to upper page of one word line. After a write destination is assigned to the upper page of one word line, a write destination is assigned to the lower page of the next word line adjacent to the one word line. In other words, write destinations are assigned in the order of the lower page of word line #i, the middle page of word line #i, the upper page of word line #i, the lower page of word line #i+1, the middle page of word line #i+1, and the upper page of word line #i+1.

The data A that has been decided to be written to the lower page of word line #0 is written to the NAND memory 120 at timing when the data B and C are confirmed, in other words, at timing t3 when the copies of the data B and C into the device area 212 are complete. The data A is held in the device area 212 until the end of a write to the upper page of word line #0 even after the write to the lower page of word line #0 is complete.

The location to be written next to the lower page of word line #0 is the lower page of word line #1 as illustrated in FIG. 2. A write to the lower page of word line #1 is caused to wait until the data E to be written to the middle page of word line #1 and the data F to be written to the upper page of word line #1 are confirmed. When the data F is copied into the device area 212 (timing t6), the data D is written to the lower page of word line #1.

In FIG. 4, the hatched write data represents unnecessary data. As illustrated, the write data becomes unnecessary on a word line basis. Hence, the data held in the device area 212 is deleted on a word line basis. For example, when the write of the data C to the upper page of word line #0 is complete at timing t9, word line #0 is in the write complete state. The data A to C that have been held in the device area 212 to be written to word line #0 then become unnecessary. When the write to the upper page of word line #0 is complete at timing t9, the data A to C are deleted from the device area 212.

In the first embodiment, the memory system 100 normally operates in MLC mode, and writes the data held in the device area 212 to the NAND memory 120 in SLC mode when receiving a FLUSH command from the host 200. The FLUSH command is a command to flush a volatile storage area (the device area 212 here). The host 200 issues the FLUSH command to the memory system 100 at times such as power off.

Data before written to the NAND memory 120 on a write request of the host 200 is hereinafter expressed as the write data.

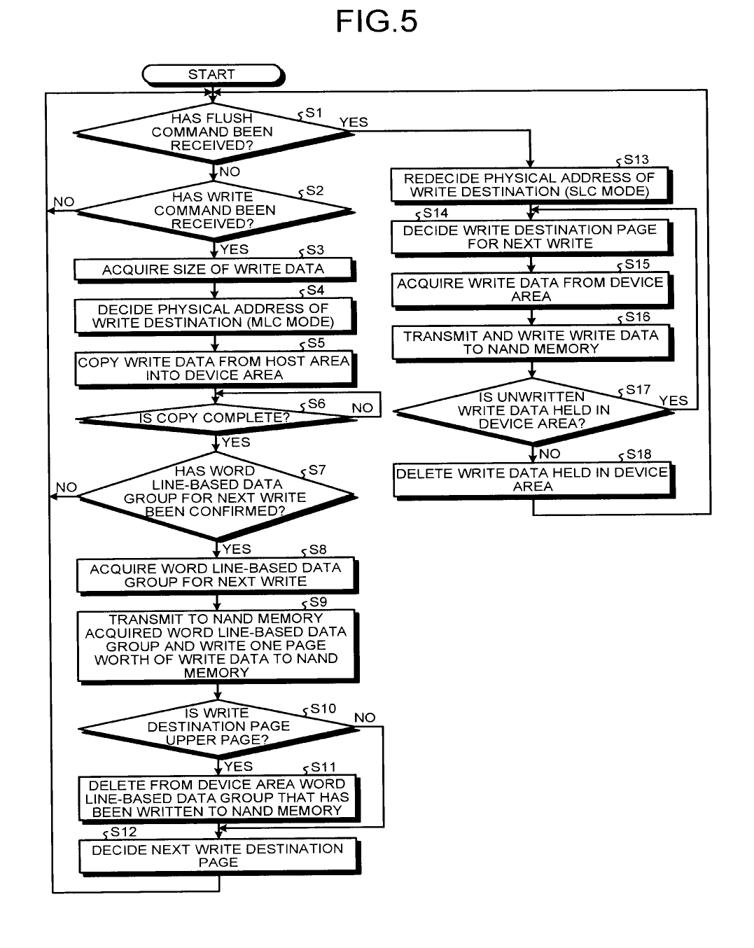

FIG. 5 is a flowchart illustrating the operation of the memory system 100 of the first embodiment.

The interface controller 111 waits for a command from the host 200. The command interpretation unit 112 determines whether or not the interface controller 111 has received the FLUSH command from the host 200 (S1). If the command interpretation unit 112 has not received the FLUSH command (S1, No), the command interpretation unit 112 determines whether or not the interface controller 111 has received a WRITE command (S2). If the command interpretation unit 112 has not received the WRITE command (S2, No), the command interpretation unit 112 re-executes the S1 process.

If the interface controller 111 has received the WRITE command (S2, Yes), the command interpretation unit 112 acquires the size of the write data (S3). The size of the write data is assumed here to be included in the WRITE command. The acquired size is transmitted to the storage device control unit 113. At this point in time, the write data is being held in the host area 211.

The storage device control unit 113 decides the physical address of the write destination of the write data (S4). The storage device control unit 113 divides the write data in page size based on the size acquired by the S3 process, and decides the physical address of a write destination page for each divided piece of data. The physical address of a write destination page is decided by the method described using FIG. 3.

The storage device control unit 113 copies the write data stored in the host area 211 into the device area 212 (S5). Specifically, for example, the storage device control unit 113 transmits, to the host 200, a COPY command to copy the write data into the device area 212. In the host 200, the interface controller 230 allows the data to be copied from the host area 211 into the device area 212 when receiving the COPY command. When the copy of the data is complete, the interface controller 230 transmits, to the memory system 100, information to the effect that the copy of the data is complete. The data is copied, for example, on a page size basis. Data that is smaller in size than the page size or data that has become redundant by being copied on a page size basis is copied into the device area 212 and merged with data requested to be written next. Accordingly, data in page size is generated.

The storage device control unit 113 determines whether or not the copies of all pieces of the write data are complete (S6). If the copies are not complete (S6, No), the storage device control unit 113 re-executes the S6 process.

If the copies are complete (S6, Yes), the storage device control unit 113 determines whether or not a word line-based write data group for the next write has been confirmed (S7). The write data to be written at the next write is expressed as the target data. The target data has a size of one page. Confirming the word line-based write data group for the next write is that all pieces of the write data to be written to a word line to which the target data's write destination page belongs exist in the device area 212. The word line-based write data group for the next write is hereinafter simply expressed as the necessary data group.

If the necessary data group is not confirmed (S7, No), the storage device control unit 113 re-executes the process of Step S1. If the necessary data group is confirmed (S7, Yes), the storage device control unit 113 acquires the necessary data group from the device area 212 (S8). The storage device control unit 113 then transmits the acquired necessary data group to the NAND memory 120, and writes the target data to a write destination page (S9).

The storage device control unit 113 subsequently determines whether or not the write destination page is the upper page (S10). If the write destination page is the upper page (S10, Yes), the storage device control unit 113 deletes the necessary page group from the device area 212 (S11). If the write destination page is not the upper page (S10, No), the storage device control unit 113 skips the S11 process.

The storage device control unit 113 subsequently decides the next write destination page based on the rule of the MLC mode (S12), and re-executes the S1 process.

If the interface controller 111 has received the FLUSH command from the host 200 (S1, Yes), the storage device control unit 113 redecides the physical address of a write destination page to write in SLC mode for the write data unwritten to the NAND memory 120 among the write data held in the device area 212 (S13). The storage device control unit 113 then decides a write destination page for the next write (S14). In the S13 process, the storage device control unit 113 assigns an address by page per word line.

The storage device control unit 113 subsequently acquires the target data for the next write from the device area 212 (S15). The storage device control unit 113 then transmits the acquired target data to the NAND memory 120 and writes the target data to the write destination page in SLC mode (S16). The storage device control unit 113 then determines whether or not the write data unwritten to the NAND memory 120 exists in the device area 212 (S17). If the write data unwritten to the NAND memory 120 exists in the device area 212 (S17, Yes), the storage device control unit 113 re-executes the S14 process. If the write data unwritten to the NAND memory 120 does not exist in the device area 212 (S17, No), the write data held in the device area 212 is deleted (S18), and the S1 process is re-executed.

The write data can be held in the device area 212 in any format. For example, each piece of the write data may be held in the device area 212 in a queue format. Moreover, each piece of the write data may be held by being arranged from the top of the device area 212 in the same order as the order of writes to the NAND memory 120. For example, the data A to L are held from the top of the device area 212 in the order of the data A, the data D, the data B, the data G, the data E, the data C, . . . when following the order illustrated in FIG. 2. The holding position of each piece of the write data in the device area 212 may be calculated by the storage device control unit 113 or the interface controller 230.

Data may be copied by an internal process in the NAND memory 120. For example, when the NAND memory 120 is operated, a process called garbage collection is generally executed. Garbage collection is a process of collecting valid data in a block and copying the valid data into another block to empty the copy source block. The storage device control unit 113 may be configured in such a manner as to collect valid data in the device area 212 and write the data collected in the device area 212 to a copy destination block upon execution of garbage collection. It may be configured such that the storage device control unit 113 executes the processes of S4 and S7 to S13 to write the data collected in the device area 212 to the copy destination block if having not received the FLUSH command, and executes the processes of S15 to S19 to write the data collected in the device area 212 to the copy destination block if having received the FLUSH command.

Data may be copied by wear leveling in the NAND memory 120. The data written to a block having a high count of writes is copied into a block having a low count of writes. Also in that case, the storage device control unit 113 once holds the data read from the copy source block in the device area 212, and subsequently writes the data held in the device area 212 to the block having a low count of writes. When writing the data held in the device area 212 to the block, the storage device control unit 113 may switch between a write in MLC mode and a write in SLC mode depending on the presence or absence of the FLUSH command as in the execution of garbage collection.

Moreover, a description has been given here assuming that the memory system 100 can copy the write data held in the host area 211 from the host area 211 into the device area 212. The memory system 100 may once acquire the write data from the host area 211, and store the acquired write data in the device area 212.

In this manner, according to the first embodiment, the storage device control unit 113 stores the write data in the external device area 212 when receiving the WRITE command. At this point in time, the storage device control unit 113 decides the destination of a write to the NAND memory 120 based on the MLC mode rule. When the necessary data group, which is all pieces of data to be written to the same word line as the target data, is confirmed, the storage device control unit 113 acquires the necessary data group from the device area 212. The storage device control unit 113 then transmits the necessary data group to the NAND memory 120 to execute a write of the target data. Moreover, when receiving the FLUSH command, the storage device control unit 113 acquires the data held in the device area 212, and writes the acquired data to the NAND memory 120 in SLC mode. Consequently, the memory system 100 can be operated in MLC mode without requiring a large-capacity, high-speed memory.

Moreover, when completing the writes of the necessary data group, the storage device control unit 113 deletes, from the device area 212, the necessary data group that has already been written. Consequently, a memory resource of the host 200 can effectively be utilized.

Moreover, the storage device control unit 113 once holds the data for a data copy in the NAND memory 120 in the device area 212, and executes a write in MLC or SLC mode in a similar procedure to the write data. Consequently, the memory system 100 can be operated in MLC mode without requiring a large-capacity, high-speed memory.

### Second Embodiment

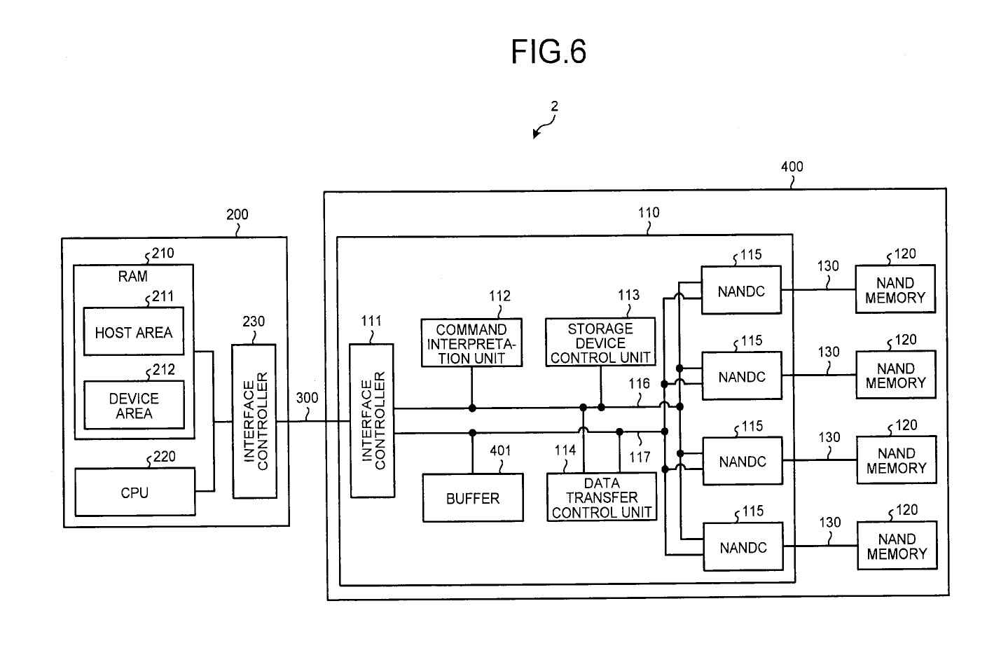

FIG. 6 is a diagram illustrating a configuration of an information processing device of a second embodiment. The same names and reference numerals as those of the components of the first embodiment are assigned to the same components as those in the first embodiment. The overlapping descriptions are omitted.

An information processing device 2 of the second embodiment includes a memory system 400 and the host 200. The memory system 400 and the host 200 are connected to each other via the communication line 300.

The memory system 400 has a configuration in which a buffer 401 is added to the memory system 100 of the first embodiment. The buffer 401 is connected to the data bus 117. In the second embodiment, the storage device control unit 113 holds the write data not in the device area 212 but in the buffer 401 when the size of the write data is smaller than a predetermined value. The storage device control unit 113 collects, in the buffer 401, the write data that is smaller in size than the predetermined value and accordingly generates the write data in page size in the buffer 401.

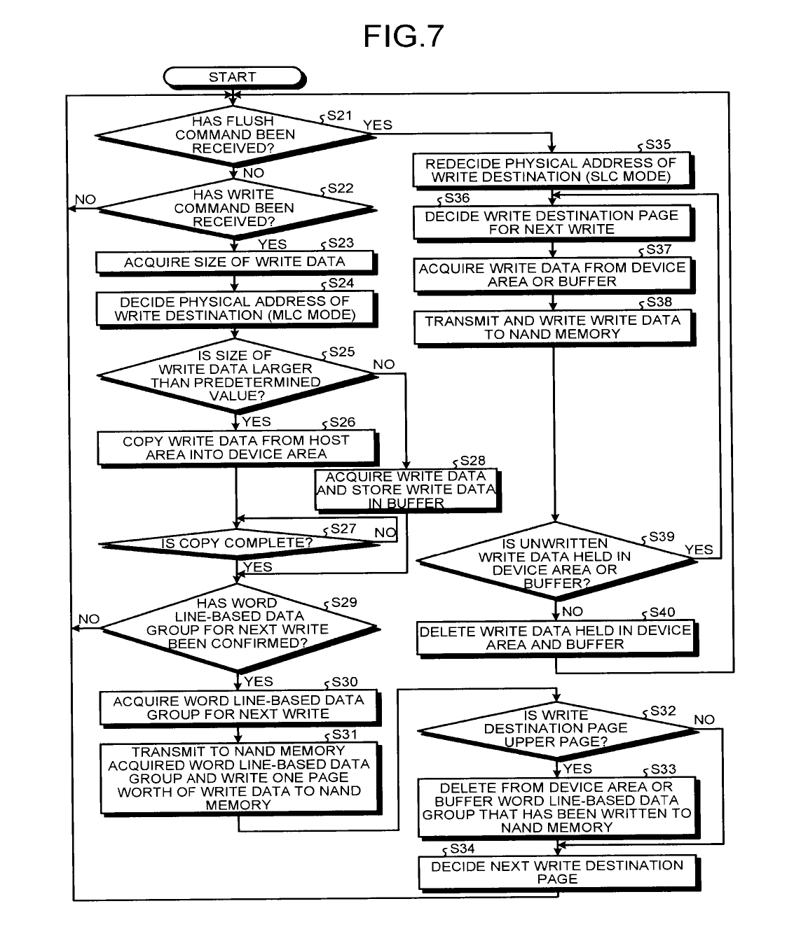

FIG. 7 is a flowchart illustrating the operation of the memory system 400 of the second embodiment.

The same processes as the processes of S1 to S4 are respectively executed in S21 to S24. After the S24 process, the storage device control unit 113 determines whether or not the write data size is larger than the predetermined value (S25). The predetermined value used for determination is freely set. The predetermined value used for determination may be, for example, a page size.

If the write data size is larger than the predetermined value (S25, Yes), the storage device control unit 113 copies the write data stored in the host area 211 into the device area 212 (S26). The storage device control unit 113 then determines whether or not the copies of all pieces of the write data are complete (S27). If the copies are not complete (S27, No), the storage device control unit 113 re-executes the S27 process.

If the write data size is smaller than the predetermined value (S25, No), the storage device control unit 113 acquires the write data from the host area 211, and stores the acquired write data in the buffer 401 (S28). Specifically, for example, the storage device control unit 113 transmits, to the host 200, a transfer command to acquire the write data from the host area 211. In the host 200, the interface controller 230 transfers the write data from the host area 211 to the interface controller ill when receiving the transfer command. The storage device control unit 113 then controls the data transfer control unit 114 to transfer, to the buffer 401, the write data received by the interface controller 111. When the transfer of the write data is complete, the interface controller 111 transmits, to the storage device control unit 113, a notification to the effect that the storage of the write data is complete.

If the copies are complete (S27, Yes), or after the S28 process, the storage device control unit 113 determines whether or not the necessary data group for the next writhe has been confirmed (S29). If the necessary data group has been confirmed (S29, Yes), the storage device control unit 113 acquires the necessary data group from the device area 212 or the buffer 401 (S30). The storage device control unit 113 then transmits the acquired necessary data group to the NAND memory 120, and writes the target data to a write destination page (S31).

The storage device control unit 113 subsequently determines whether or not the write destination page is the upper page (S32). If the write destination page is the upper page (S32, Yes), the storage device control unit 113 deletes the necessary page group from the device area 212 or the buffer 401 (S33). If the write destination page is not the upper page (S32, No), the storage device control unit 113 skips the S33 process.

The storage device control unit 113 subsequently decides the next write destination page based on the MLC mode rule (S34), and re-executes the S21 process.

If the interface controller 111 receives the FLUSH command from the host 200 (S21, Yes), the storage device control unit 113 redecides the physical address of a write destination page for the write data unwritten to the NAND memory 120 (S35) to write, to the NAND memory 120 in SLC mode, the write data unwritten to the NAND memory 120 among the write data held in the device area 212 or the buffer 401. In the S35 process, the storage device control unit 113 assigns an address by page per word line. The storage device control unit 113 then decides a write destination page for the next write (S36).

The storage device control unit 113 subsequently acquires the page size write data for the next write from the device area 212 or the buffer 401 (537). The storage device control unit 113 then transmits the acquired write data to the NAND memory 120, and writes the acquired write data to the write destination page (S38). The storage device control unit 113 then determines whether or not the write data unwritten to the NAND memory 120 exists in the device area 212 or the buffer 401 (S39). If the write data unwritten to the NAND memory 120 exists in the device area 212 or the buffer 401 (S39, Yes), the storage device control unit 113 re-executes the S36 process. If the write data unwritten to the NAND memory 120 does not exist in either the device area 212 or the buffer 401 (S39, No), the write data held in the device area 212 and the buffer 401 is deleted (S40), and the S21 process is re-executed.

If the write data that is smaller in size than the page size is requested to be written, it may take a long time to accumulate the write data up to the page size. According to the second embodiment, the storage device control unit 113 generates write data in page size by collecting, in the buffer 401 included in the memory system 400, the write data that is smaller in size than the predetermined value among the write data. In this manner, according to the second embodiment, the write data that is smaller in size than the page size is held not in the device area 212 but in the buffer 401 in the memory system 400. Accordingly, it becomes possible to prevent the memory resource of the host 200 from being occupied for a long time.

The write data held in the buffer 401 may be written in SLC mode. Moreover, if the WRITE command is a command to execute a sequential write, the write data may be held in the device area 212. If the WRITE command is a command to execute a random write, the write data may be held in the buffer 401. Moreover, if the WRITE command is a command to execute a sequential write, the write data may be written to the NAND memory 120 in MLC mode. If the WRITE command is a command to execute a random write, the write data may be written to the NAND memory 120 in SLC mode.

### Third Embodiment

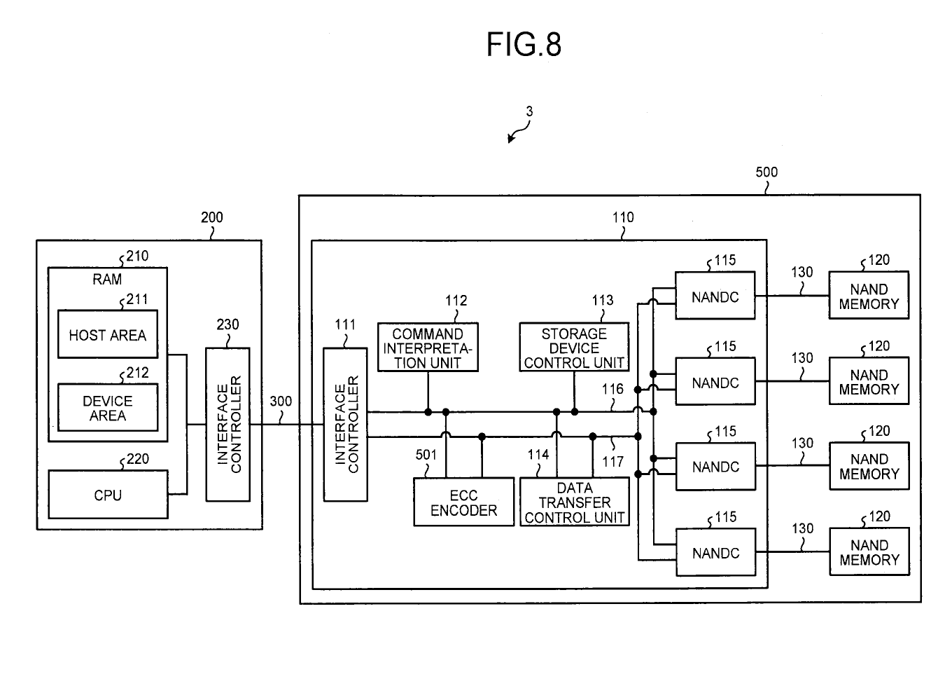

FIG. 8 is a diagram illustrating a configuration of an information processing device of a third embodiment. The same names and reference numerals as those of the components of the first embodiment are assigned to the same components as those in the first embodiment. The overlapping descriptions are omitted.

An information processing device 3 of the third embodiment includes a memory system 500 and the host 200. The memory system 500 and the host 200 are connected to each other via the communication line 300.

The memory system 500 has a configuration in which an ECC (Error Correction Code) encoder 501 is added to the memory system 100 of the first embodiment. The ECC encoder 501 is connected to the control bus 116 and the data bus 117. The ECC encoder 501 can compute the parity of the write data. The ECC encoder 501 computes parity based on the write data of a predetermined number of pages. The write data based on which parity is computed is expressed as the source data. Parity and partially computed parity are held in the device area 212 and written to the NAND memory 120 when the FLUSH command is issued. The partially computed parity is parity computed from data being smaller in volume than the predetermined number of pages since data of the predetermined number of pages necessary for the perfect computation of parity is not confirmed. Fully computed parity may be written to the NAND memory 120 on completion of the computation. The fully computed parity has, for example, a size equal to the page size.

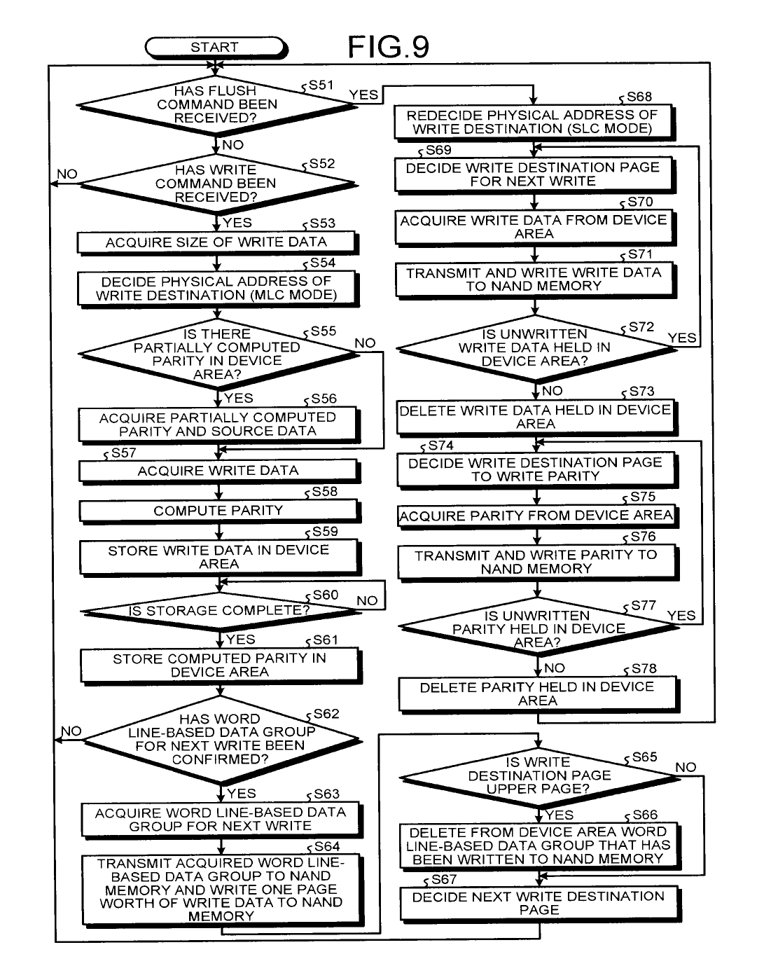

FIG. 9 is a flowchart illustrating the operation of the memory system 500 of the third embodiment.

The same processes as the processes of S1 to S4 are respectively executed in S51 to S54. After the S54 process, the storage device control unit 113 determines whether or not the partially computed parity is held in the device area 212 (S55). If the partially computed parity is held in the device area 212 (S55, Yes), the storage device control unit 113 acquires the partially computed parity and the source data of the partially computed parity from the device area 212 (S56). Whether or not the partially computed parity is held can be determined based on whether or not parity computed last was computed based on the write data of the predetermined number of pages, or computed based on the write data smaller in volume than the predetermined number of pages.

If the partially computed parity is not held in the device area 212 (S55, No), or after the S56 process, the storage device control unit 113 acquires the write data from the host area 211 (S57). The ECC encoder 501 computes parity based on the write data acquired from the host area 211 (S58). If the partially computed parity has been acquired, the ECC encoder 501 computes parity using the write data, the partially computed parity acquired from the device area 212, and the source data acquired from the device area 212.

The storage device control unit 113 subsequently transmits, to the host 200, the write data acquired from the host area 211, and stores the write data in the device area 212 (S59). The storage device control unit 113 then determines whether or not the storage of the write data is complete (S60). If the storage of the write data is not complete (S60, No), the storage device control unit 113 re-executes the S60 process. If the storage of the write data is complete (S60, Yes), the storage device control unit 113 stores the computed parity in the device area 212 (S61).

The processes of S62 to S73 are the same as those of S7 to S18. Accordingly, their descriptions are omitted.

After the S73 process, the storage device control unit 113 decides a write destination page to write the parity (S74). The parity is assumed to be written to the NAND memory 120 in SLC mode.

The storage device control unit 113 subsequently acquires one parity on a page basis from the device area 212 (S75). The storage device control unit 113 then transmits the acquired parity to the NAND memory 120 and writes the parity to the write destination page (S76).

The storage device control unit 113 subsequently determines whether or not parity unwritten to the NAND memory 120 exists in the device area 212 (S77). If parity unwritten to the NAND memory 120 exists in the device area 212 (S77, Yes), the storage device control unit 113 re-executes the S74 process. If parity unwritten to the NAND memory 120 does not exist in the device area 212 (S77, No), the parity held in the device area 212 is deleted (S78), and the S51 process is re-executed.

The already computed parity held in the device area 212 may be written to the NAND memory 120 in MLC mode if the FLUSH command has not been received.

In this manner, according to the third embodiment, the storage device control unit 113 stores the partially computed parity in the device area 212. When receiving the WRITE command, the storage device control unit 113 acquires, from the device area 212, the partially computed parity and the rest of data necessary for computation. The ECC encoder 501 computes parity based on the write data, and the partially computed parity and the source data that have been acquired from the device area 212. Consequently, error correction code can be configured in accordance with the error occurrence rate accompanied by the shrinking of the NAND memory 120 without restriction by the amount of memory included in the memory system 500.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a first memory including a non-volatile memory cell array having a plurality of word lines, the first memory being configured to operate in first mode in which n (n≧2) pieces of unit data are written per word line, and in second mode in which one piece of unit data is written per word line;
an interface connected to an external second memory; and
a control unit, wherein
the first mode is a mode in which a plurality of pieces of unit data is written in a predetermined order, and word lines to be written are switched for every write of the unit data,
the control unit
upon receiving a write request, decides a first word line to which first unit data is written, the first unit data being data requested to be written, based on the first mode and stores the first unit data in the second memory,
in the turn of the first unit data and upon n pieces of unit data to be written to the first word line existing in the second memory, acquires the n pieces of unit data to be written to the first word line from the second memory, and writes the first unit data to the first word line using the acquired n pieces of unit data to be written to the first word line, and
upon receiving a request to write all pieces of data existing in the second memory to the first memory, decides a second word line to which second unit data is written, the second unit data being unit data stored in the second memory, based on the second mode, acquires the second unit data from the second memory, and writes the second unit data to the second word line.

2. The memory system according to claim 1, wherein
upon having written the n pieces of unit data to the first word line, the control unit deletes, from the second memory, the n pieces of unit data that have already been written to the first word line.

3. The memory system according to claim 1, wherein
the control unit
copies data in the first memory based on an internal process,
reads third unit data being data targeted for the data copy from the first memory,
decides a third word line to which the third unit data is written, based on the first mode,
stores the third unit data in the second memory, and
in the turn of the third unit data and upon n pieces of unit data to be written to the third word line existing in the second memory, acquires, from the second memory, the n pieces of unit data in the second memory to be written to the third word line, and writes the third unit data to the third word line, using the acquired n pieces of unit data in the second memory to be written to the third word line.

4. The memory system according to claim 3, wherein
the internal process is wear leveling or garbage collection.

5. The memory system according to claim 2, wherein
the control unit
copies data in the first memory based on an internal process,
reads, from the first memory, third unit data being data targeted for the data copy,
decides a third word line to which the third unit data is written, based on the first mode,
stores the third unit data in the second memory, and
in the turn of the third unit data and upon n pieces of unit data to be written to the third word line existing in the second memory, acquires the third unit data from the second memory, and writes the third unit data to the third word line.

6. The memory system according to claim 5, wherein
the internal process is wear leveling or garbage collection.

7. The memory system according to claim 1, wherein
the first memory controls a voltage to write the first unit data based on the n pieces of unit data acquired from the second memory.

8. The memory system according to claim 1, further comprising a third memory, wherein
the control unit
collects, in the third memory, data smaller in size than a predetermined value among data requested to be written to generate fourth unit data,
collects, in the second memory, data larger in size than the predetermined value to generate the first unit data in the second memory,
decides a fourth word line to which the fourth unit data is written, based on the first mode, and
in the turn of the fourth unit data and upon n pieces of unit data to be written the fourth word line existing in the second or third memory, acquires the n pieces of unit data from the second or third memory, and writes the fourth unit data to the first word line, using the acquired n pieces of unit data to be written to the fourth word line.

9. The memory system according to claim 1, further comprising a third memory, wherein
the control unit
collects, in the third memory, data smaller in size than a predetermined value among data requested to be written to generate fourth unit data,
collects, in the second memory, data larger in size than the predetermined value to generate the first unit data in the second memory,
decides a fourth word line to which the fourth unit data is written, based on the second mode,
acquires the fourth unit data from the third memory, and
writes the fourth unit data to the fourth word line.

10. The memory system according to claim 1, further comprising an encoder configured to compute redundant data based on a plurality of pieces of unit data requested to be written, wherein
the control unit stores partially computed redundant data in the second memory, and acquires the partially computed redundant data, and the rest of unit data required for computation from the second memory on a request to write the first unit data, and
the encoder performs a computation based on the acquired one or more pieces of unit data, the partially computed redundant data, and the first unit data.

11. An information processing device comprising:
a memory system including
a first memory including a non-volatile memory cell array having a plurality of word lines, the first memory being configured to operate in first mode in which n (n≧2) pieces of unit data are written per word line, and in second mode in which one piece of unit data is written per word line, and
a control unit; and
a host including a second memory, wherein
the first mode is a mode in which a plurality of pieces of unit data is written in a predetermined order, and word lines to be written are switched for every write of the unit data,
the control unit
upon receiving a write request, decides a first word line to which first unit data is written, the first unit data being data requested to be written, based on the first mode and stores the first unit data in the second memory,
in the turn of the first unit data and upon n pieces of unit data to be written to the first word line existing in the second memory, acquires the n pieces of unit data to be written to the first word line from the second memory, and writes the first unit data to the first word line using the acquired n pieces of unit data to be written to the first word line, and
upon receiving a request to write all pieces of data existing in the second memory to the first memory, decides a second word line to which second unit data is written, the second unit data being unit data stored in the second memory, based on the second mode, acquires the second unit data from the second memory, and writes the second unit data to the second word line.

12. The information processing device according to claim 11, wherein
upon having written the n pieces of unit data to the first word line, the control unit deletes, from the second memory, the n pieces of unit data that have already been written to the first word line.

13. The information processing device according to claim 11, wherein
the control unit
copies data in the first memory based on an internal process,
reads third unit data being data targeted for the data copy from the first memory,
decides a third word line to which the third unit data is written, based on the first mode,
stores the third unit data in the second memory, and
in the turn of the third unit data and upon n pieces of unit data to be written to the third word line existing in the second memory, acquires, from the second memory, the n pieces of unit data in the second memory to be written to the third word line, and writes the third unit data to the third word line, using the acquired n pieces of unit data in the second memory to be written to the third word line.

14. The information processing device according to claim 13, wherein
the internal process is wear leveling or garbage collection.

15. The information processing device according to claim 12, wherein
the control unit
copies data in the first memory based on an internal process,
reads, from the first memory, third unit data being data targeted for the data copy,
decides a third word line to which the third unit data is written, based on the first mode,
stores the third unit data in the second memory, and
in the turn of a write of the third unit data and upon n pieces of unit data to be written to the third word line existing in the second memory, acquires the third unit data from the second memory, and writes the third unit data to the third word line.

16. The information processing device according to claim 15, wherein
the internal process is wear leveling or garbage collection.

17. The information processing device according to claim 11, wherein
the first memory controls a voltage to write the first unit data based on the n pieces of unit data acquired from the second memory.

18. The information processing device according to claim 11, further comprising a third memory, wherein
the control unit
collects, in the third memory, data smaller in size than a predetermined value among data requested to be written to generate fourth unit data,
collects, in the second memory, data larger in size than the predetermined value to generate the first unit data in the second memory,
decides a fourth word line to which the fourth unit data is written, based on the first mode, and
in the turn of the fourth unit data and upon n pieces of unit data to be written the fourth word line existing in the second or third memory, acquires the n pieces of unit data from the second or third memory, and writes the fourth unit data to the first word line, using the acquired n pieces of unit data to be written to the fourth word line.

19. The information processing device according to claim 11, further comprising a third memory, wherein
the control unit
collects, in the third memory, data smaller in size than a predetermined value among data requested to be written to generate fourth unit data,
collects, in the second memory, data larger in size than the predetermined value to generate the first unit data in the second memory,
decides a fourth word line to which the fourth unit data is written, based on the second mode,
acquires the fourth unit data from the third memory, and
writes the fourth unit data to the fourth word line.

20. The information processing device according to claim 11, further comprising an encoder configured to compute redundant data based on a plurality of pieces of unit data requested to be written, wherein
the control unit stores partially computed redundant data in the second memory, and acquires the partially computed redundant data, and the rest of unit data required for computation from the second memory on a request to write the first unit data, and
the encoder performs a computation based on the acquired one or more pieces of unit data, the partially computed redundant data, and the first unit data.
